(19) United States
(12) Patent Application Publication
(10) Pub. No.: US 2015/0346233 A1
(43) Pub. Date: Dec. 3, 2015

(54) WIRELESS SPEED SENSOR

(71) Applicant: TIBBO TECHNOLOGY INC., Taipei Hsien (TW)

(72) Inventor: DMITRY SLEPOV, Taipei (TW)

(21) Appl. No.: 14/727,636

(22) Filed: Jun. 1, 2015

Related U.S. Application Data
(60) Provisional application No. 62/007,174, filed on Jun. 3, 2014.

(51) Int. Cl. G01P 3/48; G01P 1/02

(52) U.S. Cl. CPC G01P 3/4802; G01P 1/026

(57) ABSTRACT

A speed and position sensing device designed for retrofitting onto the wheel of a vehicle is provided. The provided sensor transmits measurement data by means of wireless communications and thus achieves the easy installation. The provided sensor is able to power itself by harvesting the energy generated as the result of the wheel rotation.

### CROSS-REFERENCE TO RELATED APPLICATION(S)

This application claims priority under 35 U.S.C. §119(e) of the U.S. Provisional Patent Application Ser. No. 62/007,174, filed Jun. 3, 2014 and entitled, “WIRELESS SPEED SENSOR,” which is hereby incorporated by reference in its entirety for all purposes.

### BACKGROUND OF THE INVENTION

1. Field of the Invention

The present invention relates to a speed and position sensing device for retrofitting onto a vehicle lacking a built-in speedometer.

More particularly, the present invention relates to an innovative speed and position sensing device that is designed for retrofitting onto a vehicle's wheel, transmits measurement data by means of wireless communications, and powers itself by harvesting the energy generated as the result of wheel rotation.

2. Description of the Prior Art

Many types of vehicles in use today lack built-in speedometers. Examples of such vehicles are forklifts, trucks, cranes, and many other types of warehouse and construction equipment. To improve operations efficiency, such warehouse and construction machinery is often retrofitted with add-on monitoring systems tracking the speed, acceleration, utilization, vehicle running time, and other parameters of the vehicle.

A representative example of one such solution is the KLM601 vehicle monitoring system, which is commercially available from Keytroller LLC of Tampa, Fla.

The KLM601 system achieves speed monitoring through the use of a magnetic sensor kit, which is a common solution in the industry. Referring now to FIG. 1, which schematically illustrates the magnetic sensor kit of the mentioned system, the kit typically utilizes a Hall Effect sensor 1 installed in the vicinity of the wheel 2 of a vehicle. The Hall Effect sensor 1 is positioned in such a way as to detect the passing of the magnet 3 affixed to the wheel 2. As the wheel 2 rotates, the magnet 3 passes by the sensor 1, thus inducing electric pulses on the output of the sensor 1. The period of pulses and the known wheel diameter are then used to determine the moving speed of the vehicle. The output of the sensor is electrically connected to the vehicle monitoring system 4, which calculates and monitors the speed of the vehicle.

Multiple variations of this system are known in this art. In some examples, mechanical switches or reed relays are used instead of the sensors based on the Hall Effect. When the Hall sensor is used, the sensing point is often located in the gearbox. Nonetheless, all such solutions have these common elements: (1) the speed of the vehicle is calculated from the period between electric pulses coming from a sensor, and (2) these electric pulses are generated as a result of rotation of a wheel, gear, axle, or a cog whose speed of rotation is known to be proportional to the moving speed of the vehicle.

The disadvantages of the speed measurement using the mentioned solutions are well-known. First, the speed sensing based on pulses generated while the wheel turns generally cannot discriminate between the forward and backward vehicle movement. In addition, the sensor can output erroneous data if the vehicle comes to a stop with the magnet 3 being in the close proximity to the sensor 1. Such position often results in multiple pulses being generated at the slightest movement of the wheel (i.e. while the vehicle is being loaded or unloaded). The system then registers high moving speed while in actuality the vehicle is not moving at all.

Second, the sensor installation is difficult, time-consuming, and costly. The sensor 1 must be connected to the monitoring system by wires, which must be fitted inside the already assembled vehicle. The sensor 1 must be mounted at a calibrated distance from the wheel 2. Lastly, the magnet 3 has to be securely attached to the wheel and mounted at such a position as to reliable activate the sensor 1 with each turn of the wheel 3. As a result, the installation cost of the speed sensor according to the prior art far exceeds the cost of the sensor itself.

Accordingly, there exists a need for an improved speed and position sensing device that can realize easy installation, reduce the cost thereof, and enhance the sensing accuracy.

### SUMMARY OF THE INVENTION

In view of the above, it is thus an object of the present invention to provide an innovative speed and position sensing device, which is designed for retrofitting onto the wheel of a vehicle.

It is a further object of the present invention to provide a speed and position sensing device which transmits measurement data by means of wireless communications and thus achieves the ease of installation.

It is yet a further object of the present invention to provide an improved speed and position sensing device that is able to power itself by harvesting the energy generated as the result of wheel rotation.

To achieve the above objects, the present invention provides a speed and position sensing device for a vehicle including a motion tracking unit configured to detect at least one of tilting, rotating of the wheel, an angular position of the wheel, heading of the vehicle, and a vehicle running time; and to generate a data corresponding thereto. The speed and position sensing device according to the present invention further comprises a control unit, which is electrically coupled to the motion tracking unit and is configured to receive from the motion tracking unit the data and to determine at least one of a vehicle speed and a relative vehicle position change from the data. The speed and position sensing device according to the present invention further comprises a wireless communications unit, which is electrically coupled to the control unit and is configured to communicate at least the vehicle speed and the relative vehicle position change to a data collection device, such as a vehicle monitoring system, which is external to the speed and position sensing device. The speed and position sensing device according to the preferred embodiment of the present invention further comprises an energy generating unit configured to generate an electric energy from the motion of the vehicle and provide the electric energy to a power supply unit electrically coupled to the energy generating unit. The power supply unit provides electric power to the motion tracking unit, the control unit, and the wireless communications unit of the speed and position sensing device.

Preferably, the speed and position sensing device of the present invention is further equipped with an energy storage unit, which is electrically coupled to the energy generating unit and to the power supply unit. The energy storage unit is configured to receive and store the electrical energy generated by the energy generating unit. The power supply unit is configured to receive the electric energy from the energy generating unit or the energy storage unit. The energy storage unit is a battery or a supercapacitor.

Preferably, the motion tracking unit includes at least one of a gyroscope, an accelerometer, and a compass. More preferably, the gyroscope, the accelerometer, and the compass are a 3-axis gyroscope, a 3-axis accelerometer, and a 3-axis compass, respectively, and are integrated within a single integrated circuit (IC).

Preferably, the energy generating unit is an energy harvester including a prolonged cavity, a conductor coil wrapped around the prolonged cavity, and a magnet moving freely along the prolonged cavity.

Preferably, the motion tracking unit, the control unit, the wireless communications unit, the power supply unit, and the energy storage unit reside on a single circuit board.

Preferably, the speed and position sensing device includes a generally cylinder-shaped housing, and the motion tracking unit, the control unit, the wireless communications unit, the power supply unit, the energy generating unit, and the energy storage unit are housed therein. More preferably, the speed and position sensing device installs on the wheel of the vehicle through a flange, which has a plurality of mounting holes thereon.

The present invention also provides a speed and position sensing system for installation on a vehicle, said speed and position sensing system comprising a speed and position sensing device installing on a wheel of the vehicle, and a data collection device in data communication with the speed and position sensing device. The speed and position sensing device comprises a circuit board carrying thereon a motion tracking unit, a microcontroller, and a wireless communication unit. The microcontroller is configured to receive a data generated by the motion tracking unit corresponding to at least one of tilting, rotating of the wheel, an angular position of the wheel, heading of the vehicle, and a vehicle running time, to determine at least a vehicle speed and a relative vehicle position change from the data, and to communicate at least one of the vehicle speed and the relative vehicle position change to the data collection device through the wireless communication unit.

Preferably, the speed and position sensing device further comprises an energy harvester configured to generate an electric energy from the motion of the wheel. The energy harvester comprises a prolonged cavity, a conductor coil wrapped around the prolonged cavity, and a magnet in the prolonged cavity, said magnet moving freely along the prolonged cavity.

Preferably, the speed and position sensing device further comprises at least one of a battery and a supercapacitor to store the electrical energy generated by the energy harvester.

Preferably, the speed and position sensing device is housed in a generally cylinder-shaped housing.

Preferably, the speed and position sensing device installs on the wheel through a flange having a plurality of mounting holes thereon.

Preferably, the motion tracking unit comprises at least one of a gyroscope, an accelerometer, and a compass.

The features, embodiments and advantages of the aforementioned aspects and other aspects of the present invention will be further understood from the non-limiting embodiments described herein and the accompanying drawings.

### BRIEF DESCRIPTION OF THE DRAWINGS

The present invention will now be described more fully hereinafter with reference to the accompanying drawings, in which preferred embodiments of the invention are shown. It is to be understood that elements shown in these drawings are shown for the purpose of better explanation and are not necessarily presented according to the actual size and scale. In addition, to make the drawings simple and easy to understand, certain elements already known in prior art are not shown in some of the drawings.

FIG. 1 (PRIOR ART) schematically shows a conventional speed measurement system based on the Hall Effect sensor;

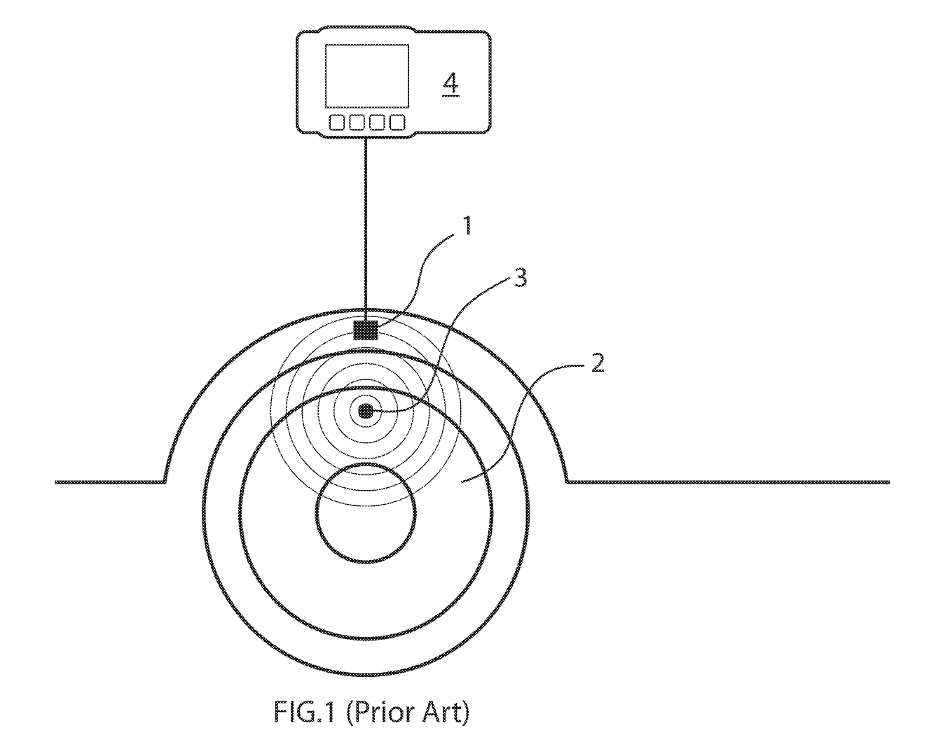

FIG. 2 is a schematic view showing the speed and position sensing system according to the preferred embodiment of the present invention; and

FIG. 3 schematically shows the installation of the speed sensing system onto a wheel of the vehicle according to the preferred embodiment of the present invention.

### DETAILED DESCRIPTION OF THE PREFERRED EMBODIMENTS

To better understand the features, aspects, advantages, and effects produced by the present invention, the invention will now be described more fully hereinafter by way of example and with reference to the accompanying drawings, in which preferred embodiments of the present invention are shown. It should be noted that the following description and accompanying drawings are given only as exemplary and do not necessarily present the actual scale or precise configuration for practicing the present invention. Hence, the scale and configuration shown in any of the accompanying drawings should not be construed as limiting the scope of the claims for carrying out the invention. It is intended that the scope of the present invention is to be defined by the claims appended hereto.

The present invention provides a speed and position sensing device for a vehicle that lacks a built-in speedometer, and the self-powered system of the same. According to one embodiment of the present invention, the speed and position sensing device is designed for retrofitting onto the wheel of a vehicle and wirelessly communicating with an external monitoring system. The speed and position sensing device according to the preferred embodiment of this invention is self-powered due to the integration of an energy harvester.

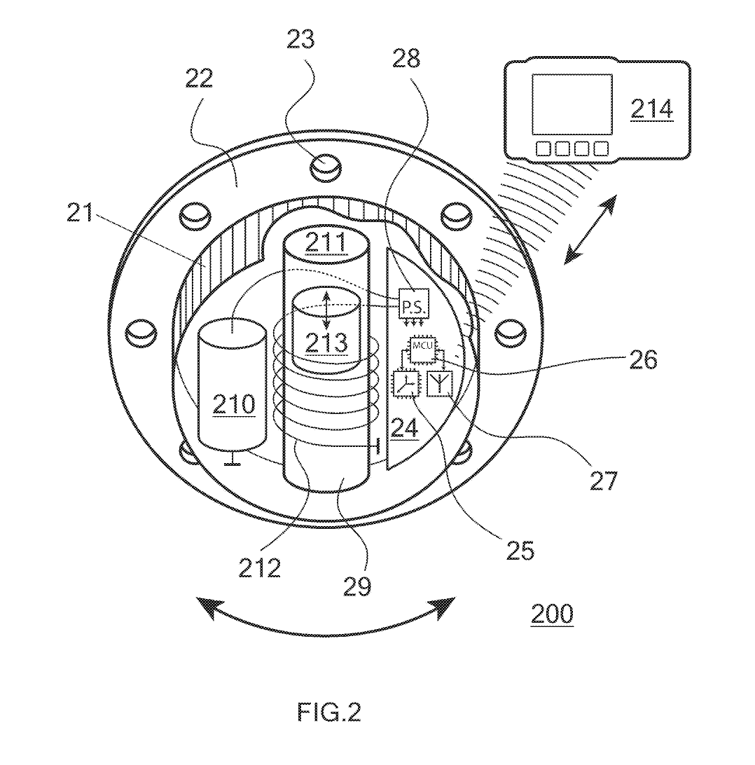

Referring now to FIG. 2, there shown a schematic view of a self-powered speed and position sensing system 200 built according to the preferred embodiment of the present invention. The speed sensing system 200 includes a speed and position sensing device that is self-powered and is mounted on a wheel of a vehicle, and a data collection device 214, which is in data communication with the speed and position sensing device. In accordance with an embodiment of the present invention, the speed and position sensing device enables the tracking of speed and position change for a vehicle.

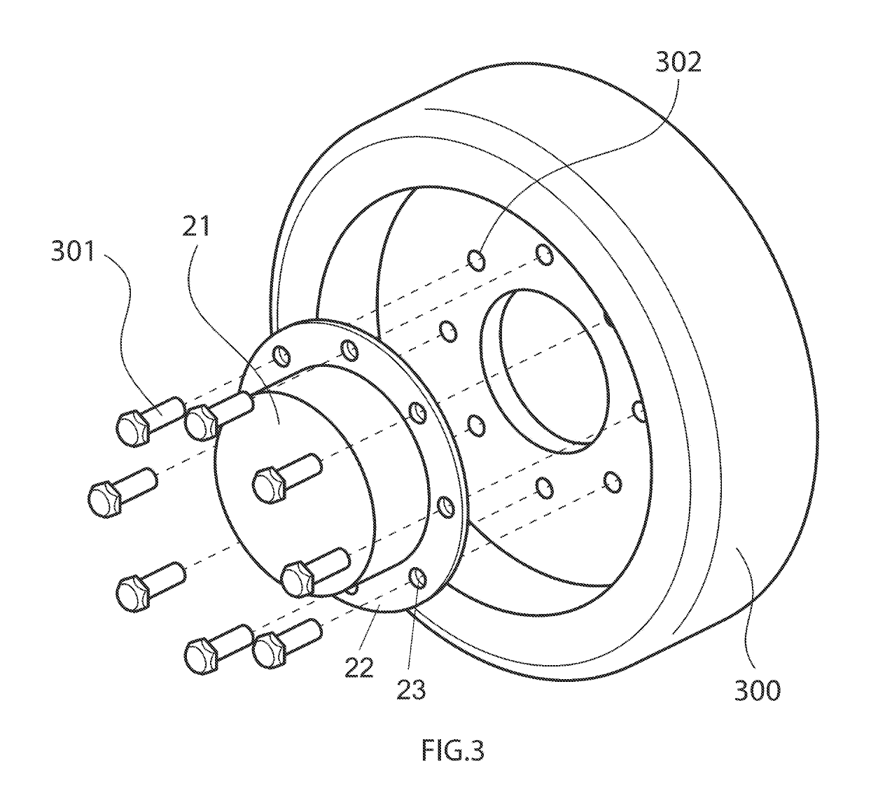

In one preferred and exemplary embodiment of the present invention, the speed and position sensing device includes a generally cylinder-shaped housing 21. The speed and position sensing device is affixed to the wheel of the vehicle through a flange 22. The flange 22 is separate from the housing 21, or can be integrally formed with the housing 21. The flange 22 has a number of mounting holes 23, through which the speed and position sensing device of the present invention would be affixed to the wheel of the vehicle by using bolts or screws, as shown in FIG. 3.

Referring now to FIG. 3, the housing 21 of the speed and position sensing device of the present invention attaches to the wheel 300 by means of a plurality of screws or bolts 301, which are inserted through a plurality of holes 23 on the flange 22. Each screw or bolt of said plurality of screws or bolts 301 is inserted into a corresponding threaded hole from the plurality of holes 302 on the wheel 300. It must be noted that threaded holes forming the plurality of holes 302 may be pre-existent, i.e. they may already be present on the wheel 300 for other purposes, such as for mounting the wheel 300 on the axle of the vehicle.

It is envisioned that the speed and position sensing device of the present invention may be offered in multiple models so as to fit the installation requirements of different vehicles. These models will vary in the number of installation holes, their positions, and sizes, depending on the application thereof. As an alternative, the speed and position sensing device of the present invention may be affixed to the wheel using epoxy or glue. Further, the flange 22 may be implemented as a separate mechanical part of the speed and position sensing system 200, and such variations are completely within the spirit and the scope of the present invention.

Located and housed within the housing 21 of the speed and position sensing device according to the present invention is the motion tracking unit, the control unit, the wireless communications unit, and the power supply unit. More specifically, the motion tracking unit, the control unit, the wireless communications unit, and the power supply unit are designed as respective electronic circuits that are carried by a circuit board. As an exemplary embodiment of the present invention, the circuit board 24 carrying the motion tracking circuit 25, the microcontroller 26, the wireless communications circuit 27, and the power supply circuit 28 is housed in the generally cylinder-shaped housing 21 of the speed and position sensing device.

The motion tracking circuit 25 tracks the motion of the wheel of the vehicle or the vehicle itself. The motion tracking circuit 25 detects at least one of tilting of the wheel, rotating of the wheel, the angular position of the wheel, heading of the vehicle, and the vehicle running time, and generates a data corresponding thereto. The motion tracking circuit may be implemented in a variety of ways.

The microcontroller 26 is electrically coupled to the motion tracking circuit 25 and receives therefrom the data reflecting at least one of the tilting of the wheel, rotating of the wheel, the angular position of the wheel, heading of the vehicle, and the vehicle running time. The microcontroller 26 processes the data supplied by the motion tracking circuit 25 to calculate the vehicle speed and the relative vehicle position change.

The wireless communications circuit 27 is electrically coupled to the microcontroller 26 and is configured to communicate at least one of the speed-related information and the relative vehicle position change-related information to the data collection device 214, which is external to the speed and position sensing device of the present invention.

The power supply circuit 28 is electrically coupled to an energy generating unit, e.g. an energy harvester 29. The power supply circuit 28 receives the electric energy generated by the energy harvester 29 and produces a stable voltage output, which is provided to the motion tracking circuit 25, the microcontroller 26, and the wireless communications circuit 27 of the speed and position sensing device.

According to one embodiment of the present invention, the motion tracking circuit 25 is implemented as an integrated circuit (IC), and includes a 3-axis gyroscope, a 3-axis accelerometer, and a 3-axis compass. As an exemplary embodiment, the motion tracking circuit 25 is a MPU-9250 9-axis motion tracking IC, which is commercially available from InvenSense Inc. As an alternative, the motion tracking circuit 25 may be implemented as a simpler motion sensor, such as the ADXL312 3-axis accelerometer IC commercially available from Analog Devices. Such variations are completely within the spirit and the scope of the present invention.

The gyroscope, when present within the motion tracking circuit 25, allows the speed and position sensing device of the present invention to measure the tilt. As the wheel rotates the tilt constantly changes thus allowing the microcontroller 26 to track the rotation of the wheel. The accelerometer, when present within the motion tracking circuit 25, allows the speed and position sensing device of the present invention to measure the gravitational and centrifugal forces. Because the gravitational and centrifugal forces are measured simultaneously in at least two axes, the microcontroller 26 can track the rotation of the wheel. The compass, when present in the motion tracking circuit 25, also allows for a measurement of tilt. Because the magnetic force is measure simultaneously in at least two axes, the microcontroller 26 can track the rotation of the wheel.

Depending on the design of the motion tracking circuit 25, the speed measurement function of the speed and position sensing device of the present invention may rely on the gyroscope, the accelerometer, the compass, or any combination of the tree sensors. Such variations are completely within the spirit and the scope of the present invention.

Further, a typical accuracy of the motion tracking circuit 25 allows the speed and position sensing device of the present invention to accurately track the angular position of the wheel. In other words, the speed and position sensing device of the present invention can track the wheel with a sub-turn precision. Armed with the angular position data, the speed and position sensing device of the present invention will not confuse forward and backward movement, and will not mistake the wheel “jitters” for the actual rotation. Thus, the speed measurement error caused by the conventional sensor is eliminated.

As an exemplary embodiment, if the motion tracking circuit 25 incorporates a compass, as is the case with the MPU-9250 IC used in the preferred embodiment of the present invention, the speed and position sensing device of the present invention can also track the vehicle heading. Since the compass is a 3-axis magnetometer, the heading can be tracked at all times and regardless of the current sensor tilt.

Combined together, the wheel angle tracking and the vehicle heading tracking can be aggregated to provide very accurate information on the wheel's path. Hence, the speed and position sensing device of the present invention can track not only the speed, but also changes in vehicle's position. Thus, the speed and position sensing device of the present invention achieves the augmenting of positioning data from a global positioning system (GPS) or some other absolute position sensing system that may be employed by the data collection device 214.

The data generated by the motion tracking circuit 25 is processed by the microcontroller 26. The speed and, when available, the position change information is then transmitted through the wireless communications circuit 27 to the data collection device 214.

In an alternative embodiment of the present invention, the microcontroller 26 does not extract the vehicle speed and the position change information from the data provided by the motion tracking circuit 25 and instead sends the raw data generated by the motion tracking circuit 25 to the data collection device 214 via the wireless communications circuit 27. According to this alternative embodiment of the present invention, it is the data collection device 214 that performs the processing of the raw data and determines the speed and the position change of the vehicle.

According to the preferred embodiment of the present invention, the microcontroller 26 and the wireless communications circuit 27 are implemented using a single integrated circuit, such as the nRF24LE1 commercially available from Nordic Semiconductor. This low-power IC combines an 8-bit CPU with a low-power 2.4 GHz ISM band radio.

It must be noted that other means of wireless communications can also be used. For example, instead of employing the ISM band wireless interface, the speed and position sensing device of the present invention may incorporate the Bluetooth, Wi-Fi, or a GPRS interface. Further, it is envisioned that some implementations of the speed and position sensing device of the present invention will feature multiple wireless interfaces. Such variations are completely within the spirit and the scope of the present invention.

The wireless data transmitted through the wireless communication circuit 27 is picked by the compatible receiver of the data collection device 214. The data collection device 214 may comprise a vehicle monitoring system, an onboard computer of a vehicle, a notebook, a tablet, a smartphone, or some other computer terminal device or a mobile device.

It must be noted that although the main direction of data transmission is from the speed and position sensing device of the present invention to the data collection device 214, as an alternative, the speed and position sensing device of the present invention is capable of bi-directional communications. That is, the data collection device 214 is able to transmit data back to the speed and position sensing device of the present invention. Such transmission may be needed, for instance, for setting up operational parameters of the speed and position sensing device of the present invention.

The speed and position sensing device of the present invention is preferably powered by the power supply circuit 28 which receives the electric power from the energy harvester 29 and/or the battery 210.

The energy harvester 29 includes a prolonged cavity 211, a conductor coil 212 wrapped around the cavity 211, and the magnet 213 moving freely along the cavity 211. As the wheel rotates, the gravitational force makes the magnet 213 repeatedly fall downwards and thus move against the conductor coil 212. Those skilled in the art will immediately realize that, as such movements occur, and in accordance with the Faraday's law of induction, an electric energy is produced in the conductor coil 212. Such electric energy is applied to the power supply circuit 28.

According to the preferred embodiment of the present invention, the energy harvester 29 includes a single cavity 211, a conductor coil 212, and a magnet 213. As an alternative, other harvester configurations may also be devised. For example, multiple cavities located in parallel, or at an angled relationship with each other may be arranged. Multiple magnet and conductor coil arrangements may be utilized as well. The energy harvester 29 may also be constructed as an electric motor affixed to the housing 21, with the rotor of said motor equipped with a weight.

In addition, alternative methods of energy harvesting may be employed. Examples of alternative methods of energy generation are piezo and thermoelectric energy harvesters. Several energy harvesters may be combined within the same device. It should be noted that such variations are completely within the spirit and the scope of the present invention.

As the energy generated by the harvester 29 is intermittent, the battery 210 is used for energy storage. The battery 210 may have a relatively small capacity and serve to smooth out the supply of electric energy as the wheel rotates, or may be relatively large so as to power the speed and position sensing device of the present invention through extended periods of vehicle inactivity. The battery used may be of the rechargeable or non-rechargeable type. A supercapacitor may also be used instead of the battery. Finally, both the battery and the supercapacitor may be employed. Such variations are completely within the spirit and the scope of the present invention.

The self-powered nature of the speed and position sensing device of the present invention eliminates the need to connect said device to power. Wireless data transmission between the speed and position sensing device of the present invention and the vehicle monitoring system 214 eliminate the need for data lines. Thus, the system installation is reduced to the task of affixing the speed and position sensing device to the wheel. Hence, the speed and position sensing device of the present invention achieves an easy and inexpensive installation.

It is also envisioned that the speed and position sensing device of the present invention can be equipped with the function of tracking the vehicle running time. Devices counting the vehicle running time are often referred to as “hour meters”. Due to the typically high sensitivity of the motion tracking circuit 25, the speed and position sensing device of the present invention can pick up subtle vibrations of the internal combustion engine and thus determine when the engine starts and stops running. The microcontroller 26 can then count the vehicle running time and periodically communicate this information via the wireless communications circuit 27.

It is further envisioned that the speed and position sensing device of the present invention does not have to always be installed exactly at the center of the wheel. Depending on the wheel's geometry it may be advantageous to attach the sensor at an offset position. Consequently, the shape of the speed and position sensing device may be altered to better fit the intended installation space. Such variations in shape are completely within the spirit and the scope of the present invention.

Finally, it is envisioned that the speed and position sensing device of the present invention may also be installed on the vehicle chassis and not on its wheel. Although such installation will eliminate the ability to accurately measure the vehicle's moving speed, the speed and position sensing device of the present invention will still be able to track heading, acceleration, and the vehicle running time of the vehicle. The 3-axis accelerometer of the motion tracking circuit 25 will still provide crude speed measurement (calculated from the acceleration and deceleration data). Positioning the speed and position sensing device of the present invention horizontally, with the cavity 211 aligned with the direction of the vehicle's forward motion, will allow the energy harvester 29 to generate the electric energy as the vehicle accelerates and decelerates.

All of the advantageous features disclosed in this specification may be joined together in any combination. Each feature disclosed in this specification may be replaced by an alternative feature serving the same, equivalent, or similar purpose. Thus, except for those particularly distinctive features, each feature disclosed is only an example of a generic series of equivalent or similar features.

While this invention has been described by way of preferred embodiments, it is to be understood that this invention is not limited hereto, and that various alterations and modifications can be made by those skilled in the art without departing from the spirit and scope of this invention.

What is claimed is:

1. A speed sensing device for installation on a wheel of a vehicle, comprising:
a motion tracking unit configured to detect at least one of tilting of said wheel, rotating of said wheel, an angular position of said wheel, heading of said vehicle, and a vehicle running time; and to generate a data corresponding thereto;
a control unit electrically coupled to said motion tracking unit and configured to receive from said motion tracking unit said data and to determine at least one of vehicle speed and a relative vehicle position change from said data; and
a wireless communications unit electrically coupled to said control unit and configured to communicate at least one of said vehicle speed and said relative vehicle position change to a data collection device external to said speed sensing device.

2. The speed sensing device of claim 1, further comprising an energy generating unit configured to generate an electric energy from the motion of said wheel.

3. The speed sensing device of claim 2, further comprising an energy storage unit electrically coupled to said energy generating unit, said energy storage unit being configured to receive and store said electrical energy generated by said energy generating unit.

4. The speed sensing device of claim 3, wherein said energy storage unit is at least one of a battery and a supercapacitor.

5. The speed sensing device of claim 1, wherein said motion tracking unit comprises at least one of a gyroscope, an accelerometer, and a compass.

6. The speed sensing device of claim 5, wherein said gyroscope, said accelerometer, and said compass are integrated as an integrated circuit (IC).

7. The speed sensing device of claim 2, wherein said energy generating unit is an energy harvester comprising a prolonged cavity, a conductor coil wrapped around said prolonged cavity, and a magnet in said prolonged cavity, said magnet being movable along said prolonged cavity.

8. The speed sensing device of claim 2, wherein said motion tracking unit, said control unit, said wireless communications unit, and said power supply unit are disposed on a circuit board.

9. The speed sensing device of claim 2, further comprising a housing, wherein said motion tracking unit, said control unit, said wireless communication unit, and said energy generating unit are housed therein.

10. The speed sensing device of claim 9, wherein said speed sensing device installs on said wheel through a flange having a plurality of mounting holes thereon.

11. A speed sensing system for installation on a vehicle, comprising:
a speed and position sensing device for installation on a wheel of said vehicle, said speed and position sensing device comprising a circuit board carrying thereon a motion tracking unit, a microcontroller, and a wireless communications unit; and
a data collection device in data communication with said speed and position sensing device,
wherein said microcontroller is configured to receive a data generated by said motion tracking unit corresponding to at least one of tilting, rotating of said wheel, an angular position of said wheel, heading of said vehicle, and a vehicle running time, to determine at least one of a vehicle speed and a relative vehicle position change from said data, and to communicate at least one of said vehicle speed and said relative vehicle position change to said data collection device through said wireless communications unit.

12. The speed and position sensing system of claim 11, wherein said speed and position sensing device further comprises an energy harvester configured to generate an electric energy from the motion of said wheel.

13. The speed and position sensing system of claim 12, wherein said energy harvester comprises a prolonged cavity, a conductor coil wrapped around said prolonged cavity, and a magnet in said prolonged cavity, said magnet being movable along said prolonged cavity.

14. The speed and position sensing system of claim 12, wherein said speed and position sensing device further comprises at least one of a battery and a supercapacitor to store said electrical energy generated by said energy harvester.

15. The speed and position sensing system of claim 11, where said speed and position sensing device is housed in a generally cylinder-shaped housing.

16. The speed and position sensing system of claim 11, wherein said speed and position sensing device installs on said wheel through a flange having a plurality of mounting holes thereon.

17. The speed and position sensing system of claim 11, wherein said motion tracking unit comprises at least one of a gyroscope, an accelerometer, and a compass.

18. The speed sensing system of claim 17, wherein said gyroscope, said accelerometer, and said compass are integrated as an integrated circuit (IC).
